(19) United States
(12) Patent Application Publication
(10) Pub. No.: US 2014/0180871 A1
(43) Pub. Date: Jun. 26, 2014

(54) Method, System and Program Product for Online Commercial and Social Activity

(71) Applicant: Giancarlo Mignano, Miami, FL (US)

(72) Inventor: Giancarlo Mignano, Miami, FL (US)

(21) Appl. No.: 13/584,761

(22) Filed: Aug. 13, 2012

Related U.S. Application Data
(60) Provisional application No. 61/568,272, filed on Dec. 8, 2011.

(51) Int. Cl. G06Q 30/06; G06Q 50/00

(52) U.S. Cl. CPC G06Q 30/0613; G06Q 50/01
USPC 705/26.41

(57) ABSTRACT

Method, system and program product comprise requesting to join a trading network of a website. Said trading network is established for commercial and social activity. Said request is transferred to a share network engine to be posted on an out of network board to be viewable by all consumer members and merchant members. Said request is acceptable by any member of said trading network. An acceptance of said request is received from said share network engine. At least a voucher for a product or service provided by at least one merchant member of said trading network is received. Information is transferred to said share network engine to be at least posted on a board of said trading network.

### CROSS-REFERENCE TO RELATED APPLICATIONS

The present Utility patent application claims priority benefit of the U.S. provisional application for patent Ser. No. 61/568,272 entitled “Trading Share Network Association Mapping System And Method” filed on 8-Dec.-2011, under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a matching service. More particularly, one or more embodiments of the invention relate to matching buyers and sellers through an online social site.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that social network settings are increasingly common in society. Many users find socializing through the internet to be both convenient and effective for interacting with others of similar interest. A commonality of social networks is that members of the social network tend to influence one another's behavior, including their buying habits.

Typically, marketing to social networks can be productive for at least a couple of reasons. First, a product can be targeted to social networks that tend to be interested in the product. For instance, video games can be marketed to a web-site based social network dedicated to gaming. Second, since at least some members of the social network influence other members, once introduced to these key influential members, the social network can potentially ‘self-market’ the product. This self-marketing aspect can be thought of as viral marketing since one member's use and satisfaction with the product tends to be conveyed to other members and influences the other members' perception of the product.

Typically, social shopping is a method of e-commerce where shoppers' friends become involved in the shopping experience. Social shopping attempts to use technology to mimic the social interactions found in physical malls and stores.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1a through 1e illustrate exemplary block diagrams of the trading network architecture, in accordance with an embodiment of the present invention;

FIGS. 2a and 2b illustrate an exemplary process for registering for membership on the trading network, in accordance with an embodiment of the present invention, where FIG. 2a illustrates a flowchart showing the process for registration, and FIG. 2b illustrates an exemplary registration page 210;

FIG. 3 illustrates an exemplary trading network category page 216 on the website of the trading network for categorizing products and services, in accordance with an embodiment of the present invention;

FIGS. 4a through 4g illustrate exemplary trading network online pages for a consumer, in accordance with an embodiment of the present invention;

FIGS. 5a through 5f illustrate exemplary trading network online pages for a merchant, in accordance with an embodiment of the present invention;

FIG. 6 illustrates a typical computer system that, when appropriately configured or designed, can serve as a computer system in which the invention may be embodied; and

FIG. 7 illustrates a flowchart diagram of an exemplary trading network social site method, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

The present invention will now be described in detail with reference to embodiments thereof as illustrated in the accompanying drawings. In the following description, the term merchant is intended to be interpreted broadly as to include various business entities such as, but not limited to, manufactures of products, distributers of products, providers of services, professionals providing a service, etc.

There are various types of free market trading network social site methods and systems 100 that may be provided by preferred embodiments of the present invention. For example, without limitation, one type of free market trading network social site method and system may match merchants 200 with consumers 202 to create an open, and opportunity laden online community that encourages commercial activities and provides informative feedback for both merchants and consumers. The present invention may provide a novel method and system for creating synergy between the communication aspects of a social site, and the efficient commercial embodiments of a commercial trading site.

In some embodiments, the merchant may register the company, product, or service being offered with the trading network through a website. However, in other embodiments, the merchant may access the trading network website, even as a nonmember to request permission to register and join the trading network. Those skilled in the art, in light of the present teachings will recognize that the website may operate itself through standard online operation, e.g., without limitation, processors, servers, databases, and other computer or machine based components. In some embodiments, the merchant registration information becomes accessible to both merchants and consumers in the trading network. The merchant may create a merchant home page 204 on the trading network that, in essence, may represent a virtual storefront. The merchant virtual storefront may include, without limitation, information about the company, information about the products and/or services, history of the company, promotions, events, and contact information. The merchant may also include a hyperlink that sends a user to a website outside the trading network. In some embodiments, the merchant sited may include a video or a catalog of photographs to further promote the product or sevice. The merchant may invite other merchants to the trading network to increase commercial activity and opportunities for both merchants and consumers. In one alternative embodiment, the merchant may form an exclusive community within the trading network with other merchants having analogous products and/or services.

In some embodiments, the consumer may also register personal information with the trading network. The consumer may access the trading network, even as a nonmember to request permission to register and join the network. The registration information may include, without limitation, name, email address, phone number, interests, annual income, gender, race, age, and purchasing habits. In some embodiments, the consumer may receive discounts, gifts, and promotions for registering. Once the consumer becomes a member of the network, the consumer may search for products and services on the website. The consumer may also receive vouchers 208, offered by the network and various merchants, to purchase products and services. In some embodiments, the consumer may perform a plethora of consumer related activities, including, without limitation, posting reviews and comments pertinent to the merchant's products and services, refering other consumers to a product or service, applying for merchant discounts, and participating in chat rooms that include consumer and/or merchants. In some embodiments, the merchant may provide incentives that the consumer may take advantage of, including, without limitation, discounts for refering and inviting other consumers to the merchant or trading network, discounts for logging on to the trading network website a minimum number per time interval, and discounts for giving a merchant higher reviews. In some embodiments, the consumer may post a consumer home page 206 on the trading network website. The consumer home page allows the consumer to present a more unique and personalized embodiment of commercial tastes and preferences to the other merchant and consumer members. The personal page may include, without limitation, a review portion, a message post portion, a photograph of the consumer, and a promotion update setion. The merchant may also transmit a promotion to the consumer personal page for the consumer, and visiting consumers to utilize.

In some embodiments, the trading network utilizes a categorization system to assist the consumer in diserning between the different types of merchant products and services. The merchant may decide which category or group of categories the products and sevices best fall under. The trading network may provide myriad permutations of categories now known, or later developed, including, without limitation, “Product or Service”, “Name, Address, Phone, Zip Code”, “Woman Apparel, Teen Fashion, Men Apparel, Swimwear, Underwear”, “Proffesional Services, Typing, Writing, Auditing, Accounting”, and the like. For example, without limitation, a shoemaker would classify under both “Products” and “Services” since the shoemaker may both sell and repair shoes. The shoemaker would also select to be categorized under “Footwear” and “Clothes”. The shoemaker may select to offer promotions for sandals to consumer members who live in southern states, and similar promotions for heavy boots to consumer members who live in northern states, so as to maximize association with pertinent consumers on the trading network. In this manner, the merchant may custom tailor the products and services to match the tastes of the consumers. In one alternative embodiment, the consumer and merchant may pay a fee to join the trading network. However in other embodiments, the trading network is free to join. In some embodiments, the consumer and the merchant may open a personal account, e.g., without limitations, Pay Pal, piggy bank account, and the like, and purchase products and services with funds deposited into the account. In some embodiments, the merchant may deposit funds into the consumer's account for performing consumer activities, including, without limitation, referring other consumers, transacting a minmum quota of purchases, and posting positive reviews.

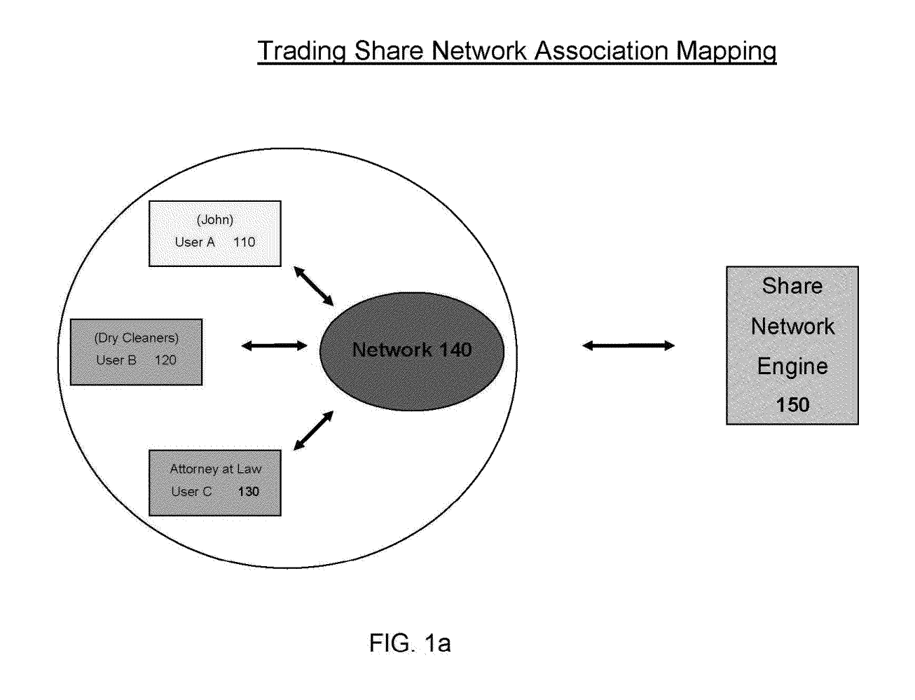

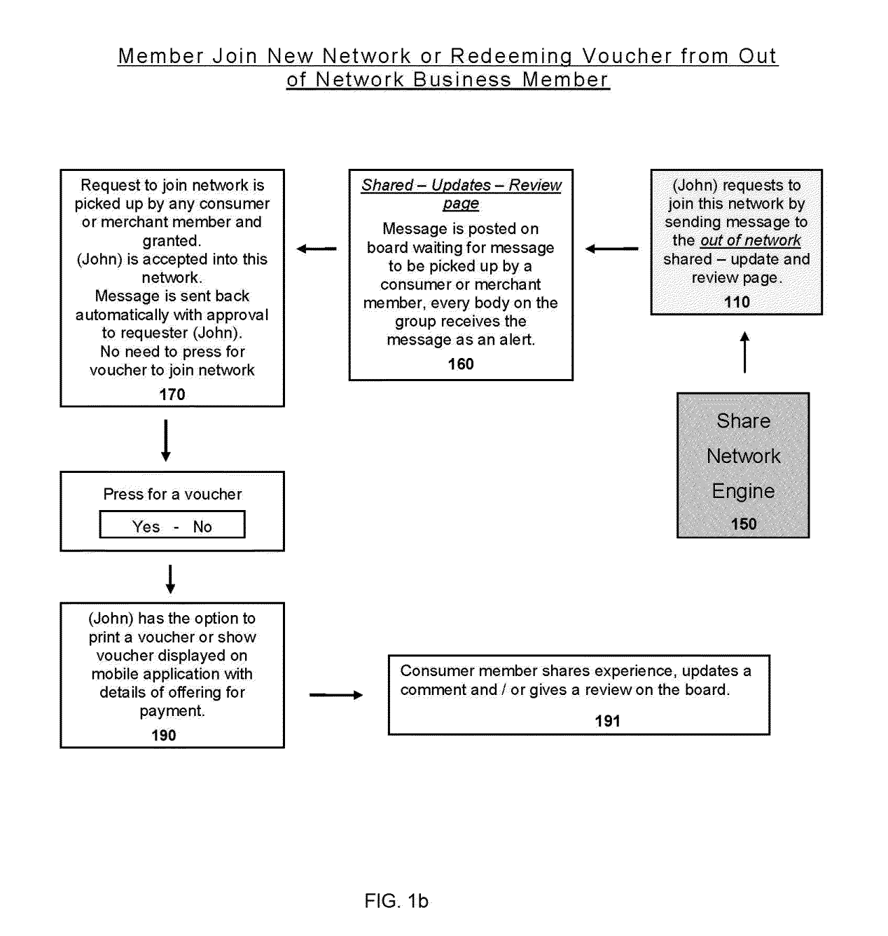

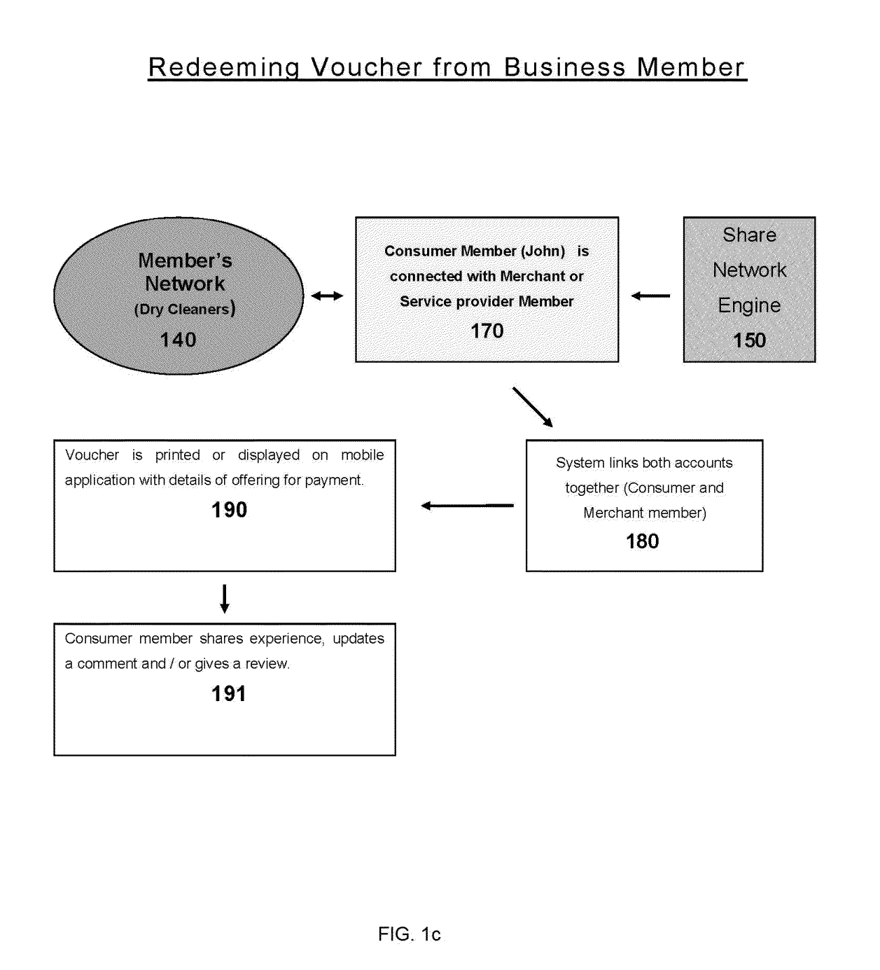

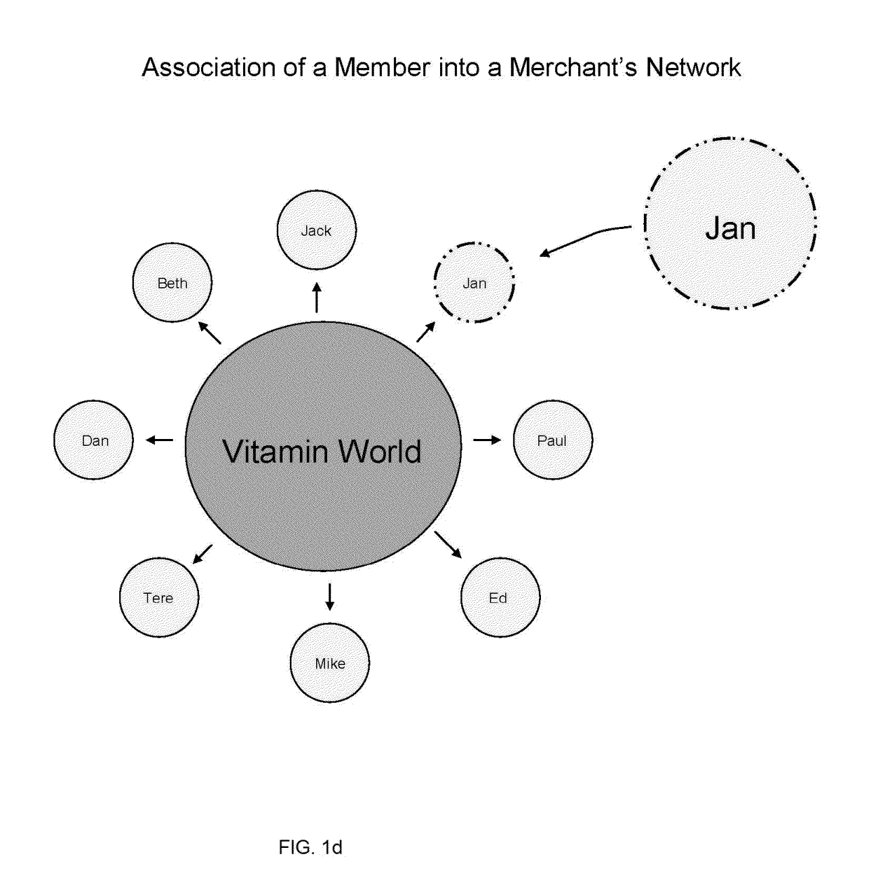

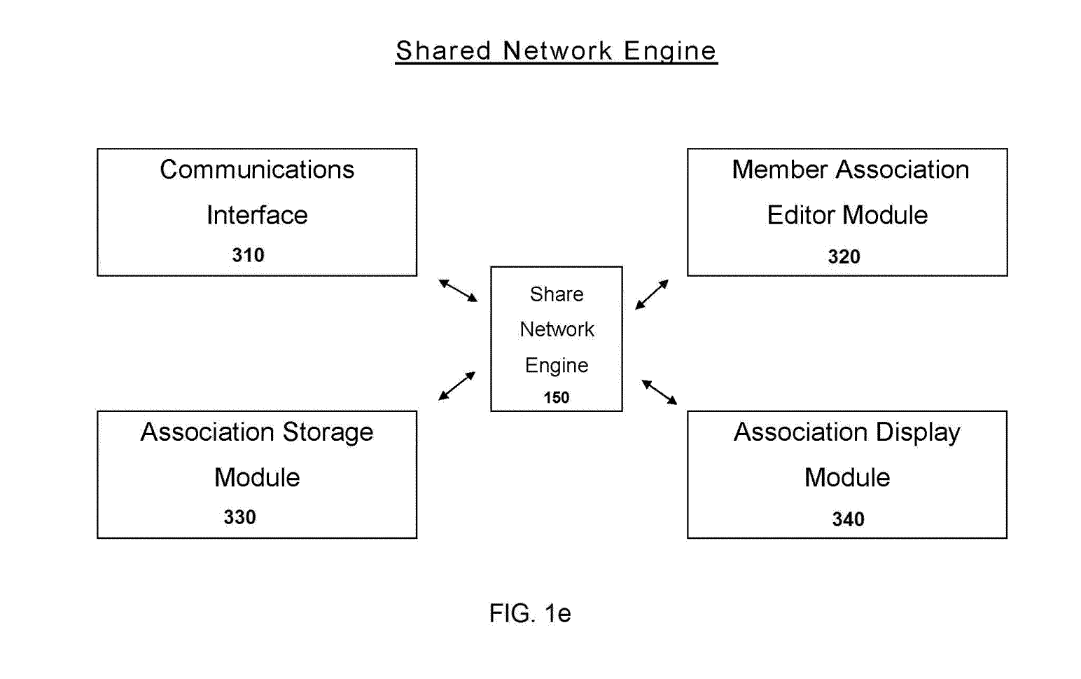

FIGS. 1a through 1e illustrate exemplary block diagrams of the trading network architecture, in accordance with an embodiment of the present invention. FIG. 1a illustrates an exemplary interaction of users in a trading network 140. In some embodiments a multiplicity of network members interacts with each other and the trading network for commercial and social activity. User A 110 represents a consumer, a User B 120 represents a service provider, including without limitation a dry cleaner, and User C 130 represents a service provider, including, without limitation, an attorney. A Share Network Engine 150, including, without limitation, a processor, a database, and a server, may store and process information and activities of the network members. In some embodiments, the Users may interact with each other through the trading network. In one alternative embodiment, User B and User C, the merchants of the trading network, may exclude User A, the consumer, for selected activities, including, without limitation, product source comparison, inventory control, and pricing comparisons. The trading network receives and transmits information and activities from the network members for processing by the Share Network Engine. In one alternative embodiment, the information may be utilized in statistical algorithms to predict consumer buying habits and merchant profitability factors throughout the year.

FIG. 1b illustrates an exemplary process for registering network members and redeeming vouchers in the trading network. In some embodiments, User A 110 accesses the online website of the trading network as a nonmember, and requests to join the trading network by sending a message outside of the network to members and nonmembers. The request is posted 160 on a message board that the network members and nonmembers may view. Any member may approve 170 User A's request, and the approval is transmitted back to User A. User A accepts, and is given the option to obtain a voucher for purchasing products and services, and receiving discounts from merchants on the trading network. Those skilled in the art, in light of the present teachings, will recognize that User A may print the voucher 190 or display the voucher on a smart phone application to redeem the voucher. In one alternative embodiment, the consumers may form a bartering community within the trading network and use the vouchers to trade services with each other. For example, without limitation, User A gives the voucher to an elderly woman to babysit children. The elderly lady may then use the vouchers obtained from User A to pay for dry cleaning from User B. User A may then share the experience with other members through numerous channels, including without limitation, a chat room and a posted review.

FIG. 1c illustrates an exemplary process for redeeming the voucher. In some embodiments, the Share Network Engine may be intelligent enough to link a consumer and a merchant 180 together. The consumer and the merchant may have a history of selling and purchasing an identical product, or category off service. In some embodiments, the Share Network Engine may identify requests from the message board 214 to link the consumer and merchant. The consumer may then print and redeem the voucher. Finally, the consumer may then share the experience with other members through numerous channels, including without limitation, a chat room and a posted review.

FIG. 1d illustrates an exemplary process for a network member joining an association of members of a merchant's network. The consumer may join a specific category of product or service to receive and transmit information, reviews, and promotional offers pertinent to the product or service. For example, without limitation, the consumer may join an association comprising of a merchant and a multiplicity of consumers for vitamin products. The vitamin association may perform numerous activities pertinent to vitamins, including, without limitation, discussing health issues, exercise techniques, and human anatomy.

FIG. 1e illustrates an exemplary process for the interaction between the different modules and interfaces in the trading network. In some embodiments, the Share Network Engine may exchange information with a Communications Interface 310. The Communication Interface may display the merchant and consumer information processed by the Share Network Engine. In some embodiments, numerous members of an association may communicate and view information through the Communication Interface. The Communication Interface may include, without limitation, a computer screen, a smart phone display, an LCD screen, and a plasma screen. In some embodiments, the Share Network Engine may exchange information with a Member Association Editor Module 320. The Member Association Editor Module may provide numerous options for the consumer or merchant. In some embodiments, as the consumer or merchant enter information into, or selects an option from the Member Association Editor Module, the information is transmitted, stored, and processed by the Share Network Engine. The resultant information may then be applied to the member's personal settings and display on the Communication Interface. In some embodiments, the Member Association Editor Module may include, without limitation, basic personal information, a photograph, posting comments, searching categories, viewing other members, invite friends from other social networks or the trading network, view a personal account, print vouchers, and display a map for locating merchants. In some embodiments, the Share Network Engine may exchange information with an Association Storage Module 330. The Association Storage Module 330 may allow a group of merchants and consumers to store information pertinent to a specific category of product or service. The association may then access and discuss the stored information, even as the Share Network Engine continues to update the information with new input. In some embodiments, the Share Network Engine may exchange information with an Association Display Module 340. The Association Display Module may display information pertinent to the association. The consumers and members may access the Association Display Module to view other members in the association. The membership list in the Association Display Module may be constantly updated through interaction with the Share Network Engine.

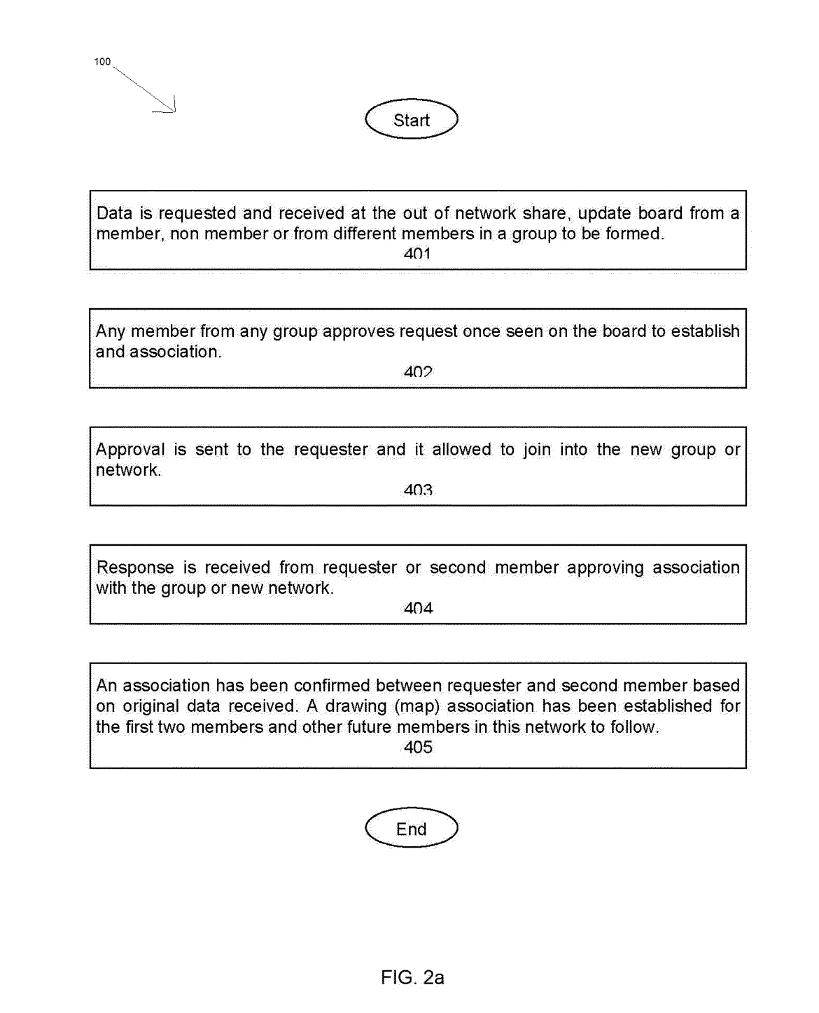

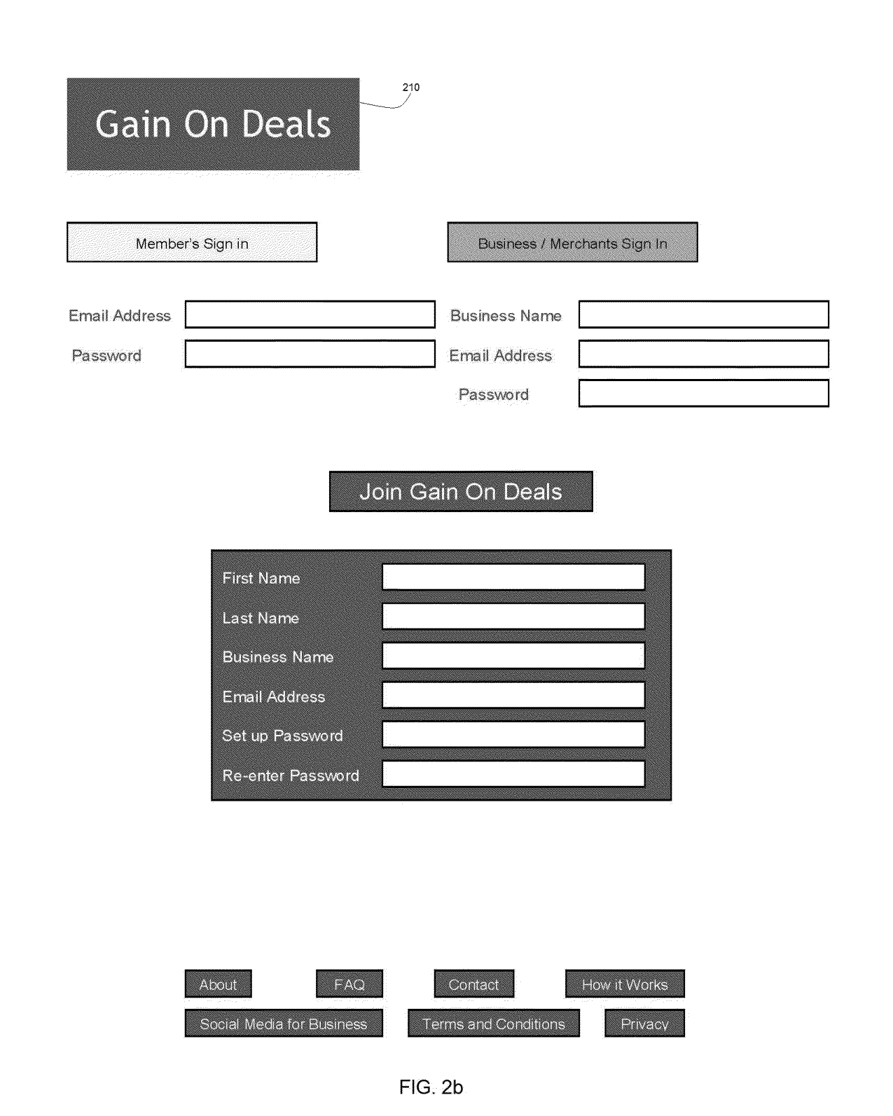

FIGS. 2a and 2b illustrate an exemplary process for registering for membership on the trading network, in accordance with an embodiment of the present invention. FIG. 2a illustrates a flowchart showing the process for registration, and FIG. 2b illustrates an exemplary registration page 210. In the present embodiment, the trading network may include a first step 401, of requesting data from the interested merchant or consumer. The registration information may be received outside of the trading network or within the trading network by merchant and consumer members, nonmembers, or from different members in a group to be formed. A second step 402 involves approving the merchant or consumer for entry into the trading network. In some embodiments, any trading network member 212 may approve the requested entry. In a third step 403, approval may be transmitted to the requesting consumer or merchant. Those skilled in the art, in light of the present teachings, will recognize that the approval may be transmitted by email, a message board, telephone, or mail. The approval may also include promotions and information regarding the trading network, and merchants and consumers in the trading network. In one alternative embodiment, the approved consumer may receive a digital booklet that assists the consumer in identifying attractive categories of the trading network based on the consumer's registration information. A next step 404 involves the approved consumer or merchant responding to the trading network to accept membership. A final step 405 in registration may involve the new consumer or merchant forming an association with other members in the trading network. In some embodiments, the new member may familiarize with the trading network through various means, including, without limitation, joining chat rooms, requesting promotions from specific categories of products and services, and requesting and spending vouchers obtained from other members of the trading network. In this manner, the new member may best decide which group of merchants and consumers to associate with. In some embodiments, the registration page receives information from the aspiring member that helps other members understand the potential consumer or merchant needs, habits, products, and services. The information requested may include, without limitation, name, address, email, age, sex, marital status, and the like. The registration page may also include information for assisting the aspiring member to decide whether membership is appropriate, including, without limitation, frequently asked questions, information about the trading network, contact information, and privacy concerns.

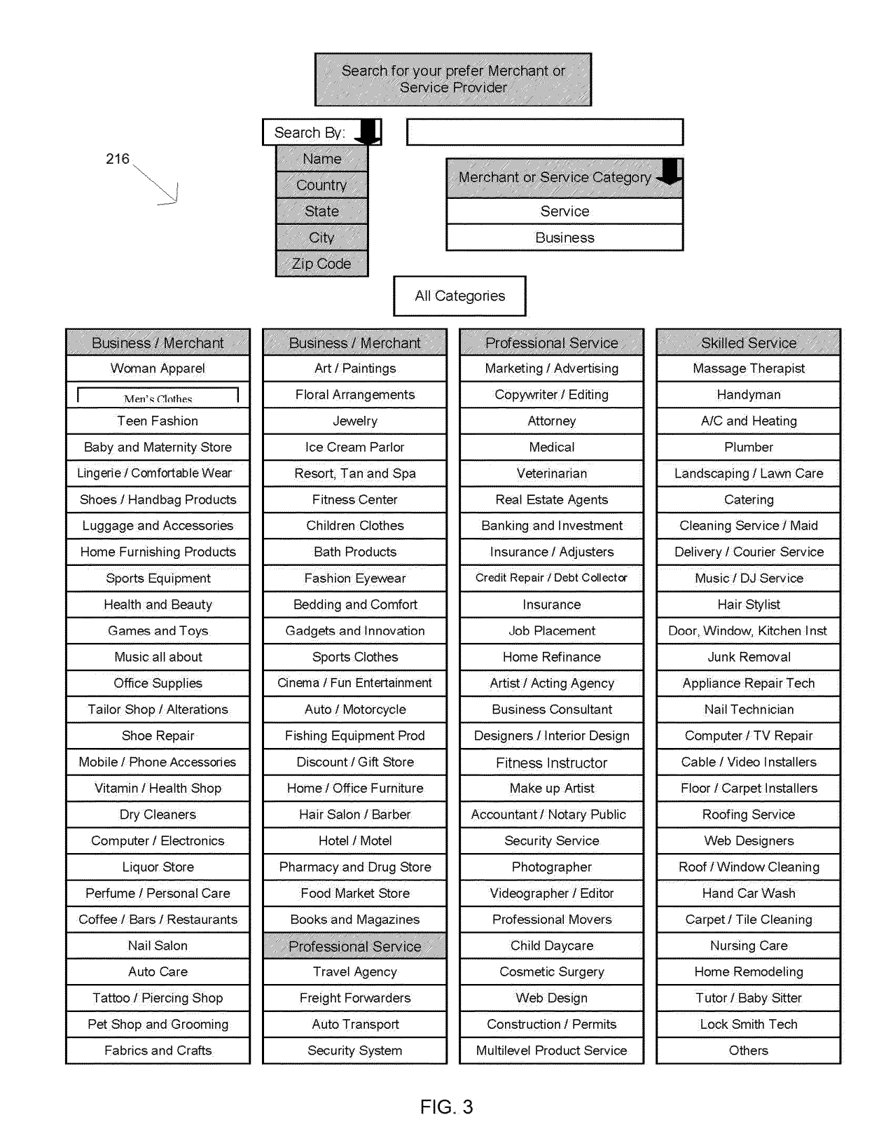

FIG. 3 illustrates an exemplary trading network category page 216 on the website of the trading network for categorizing products and services, in accordance with an embodiment of the present invention. The category page allows a consumer to efficiently select a product or service category and subcategory. The merchant may also place the product or service in the appropriate category and subcategory. For example, without limitation, the consumer may select a “Service”. Then the consumer may select a region, “New York City”. The Consumer may then select the category of “Clothing”, and then the subcategory of “Women's Apparel”. In some embodiments, the merchant may place a product in multiple categories. For example, without limitation, a shoemaker may be accessible under “Services” for repairing shoes, and “Products” for selling shoes.

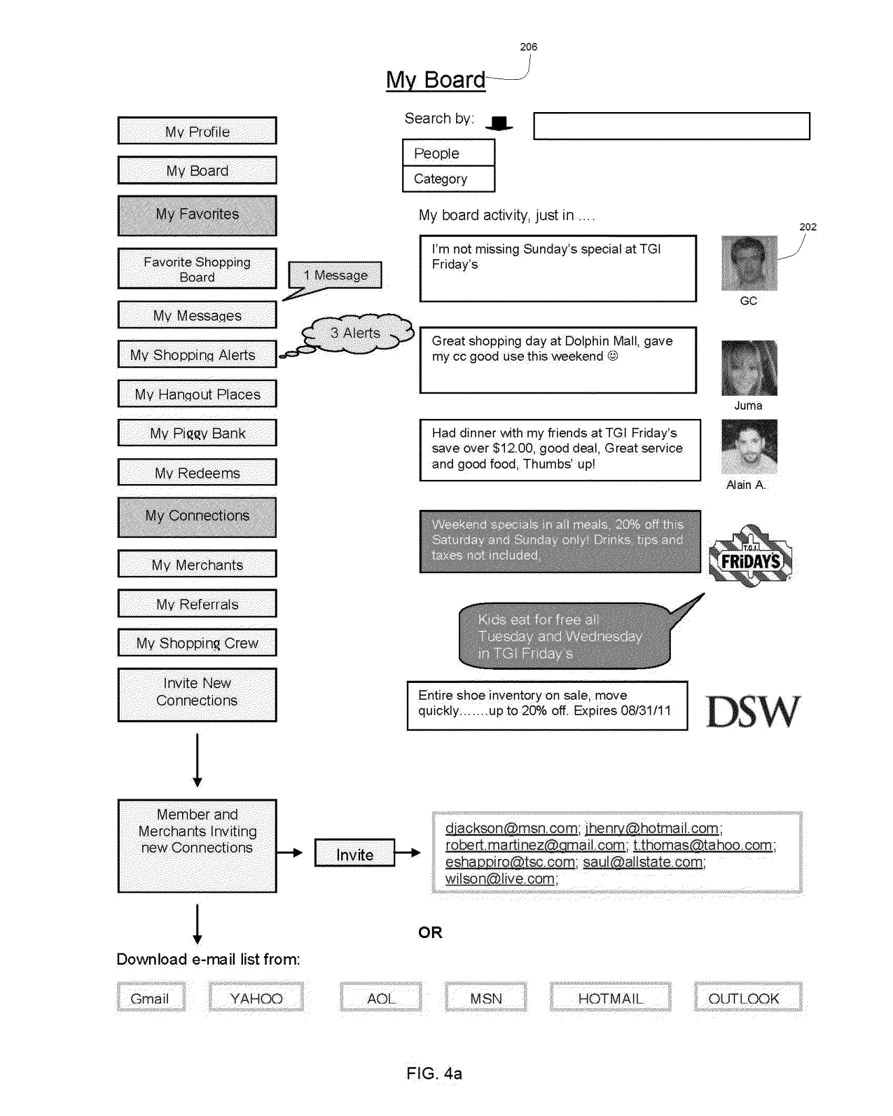

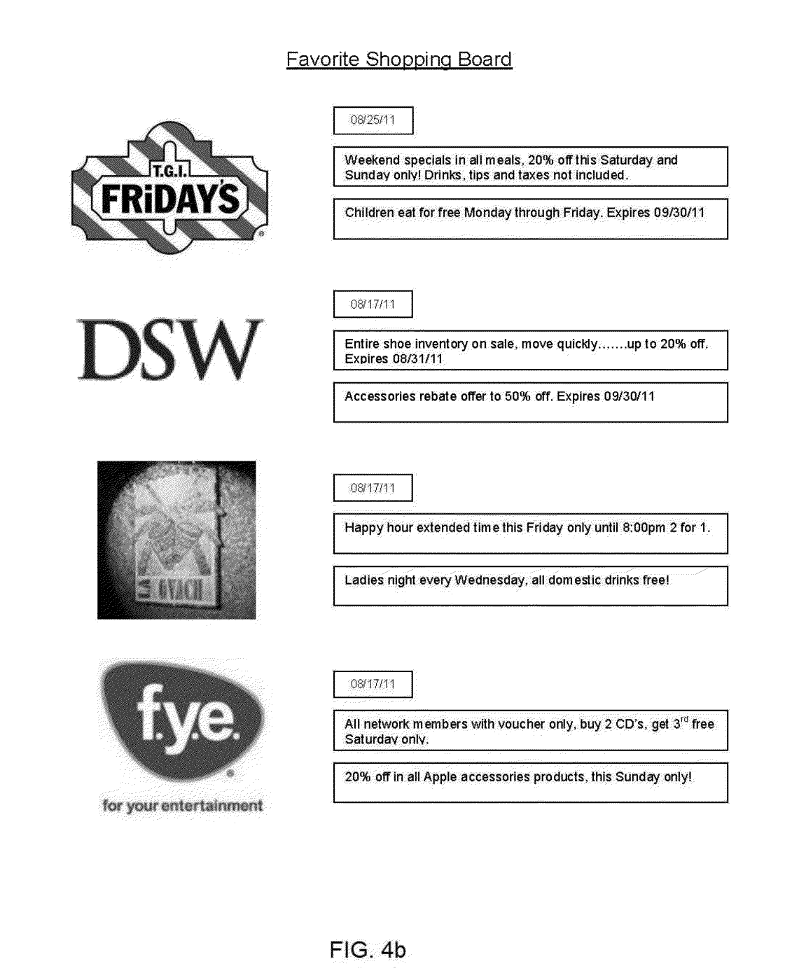

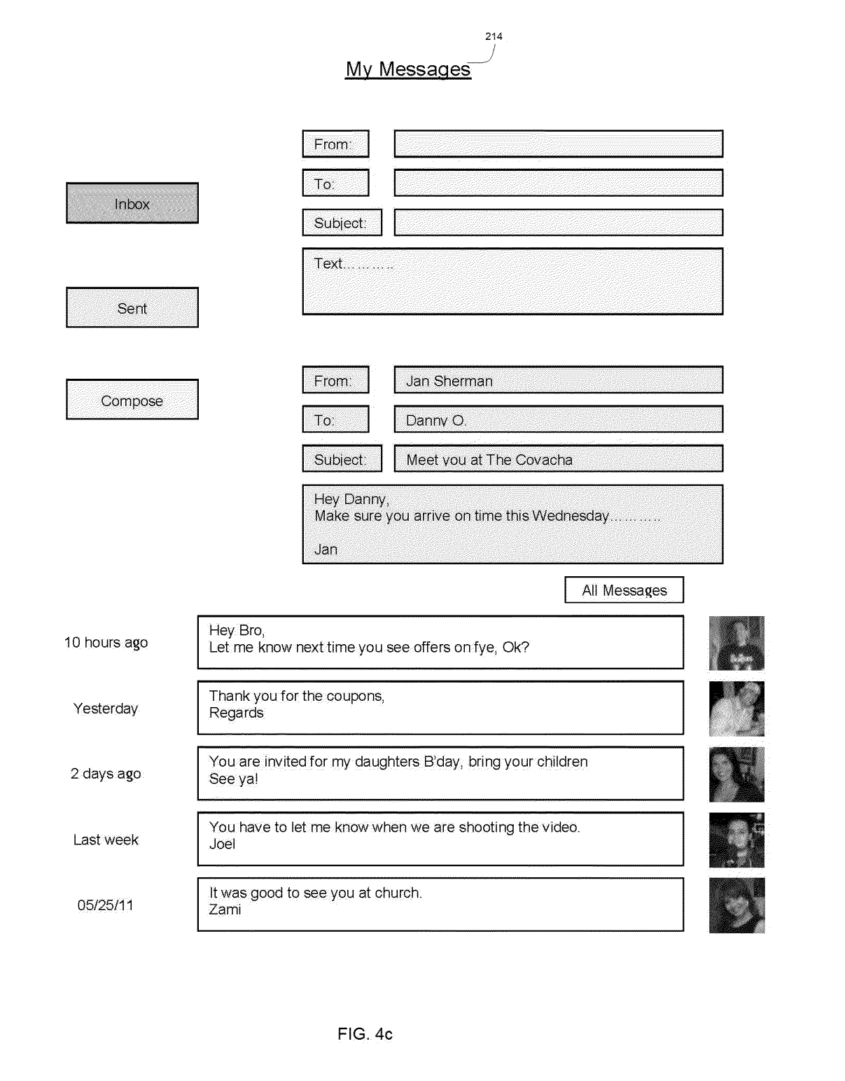

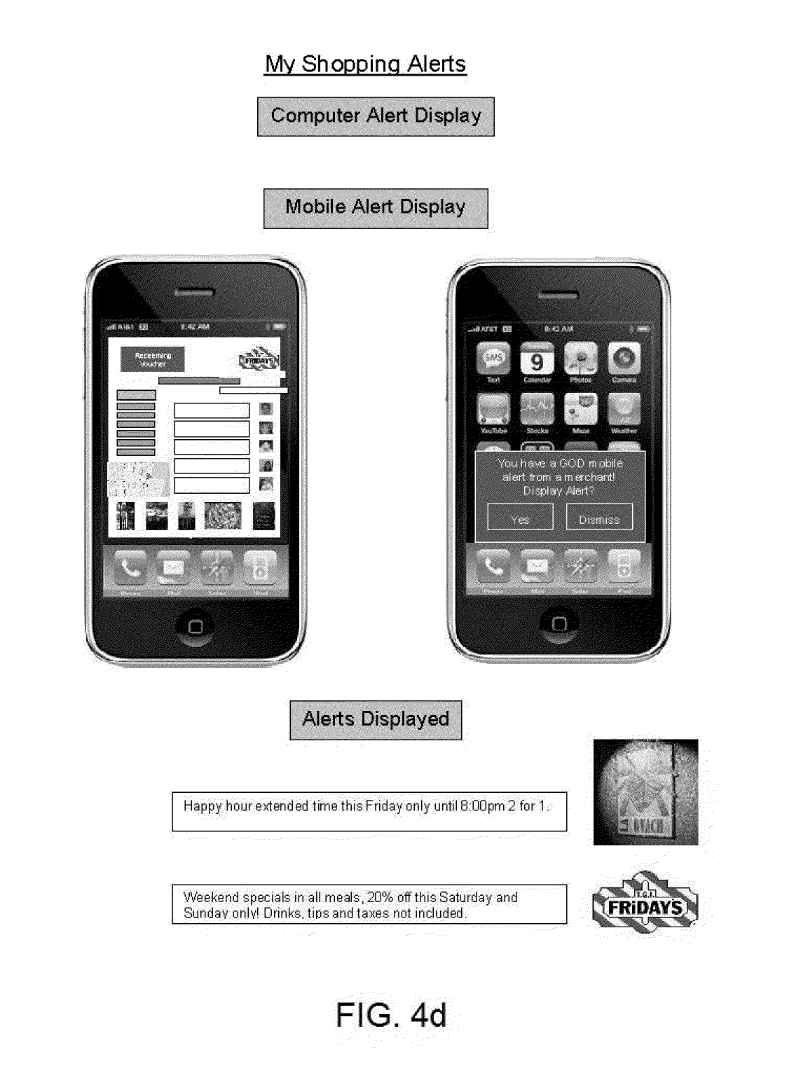

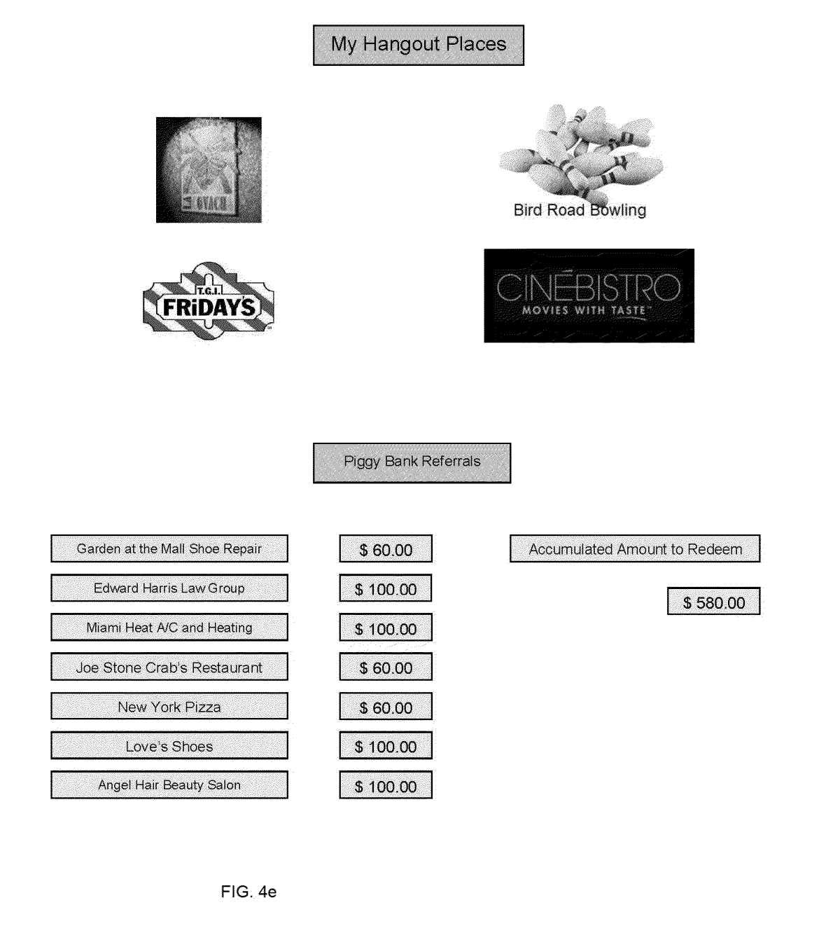

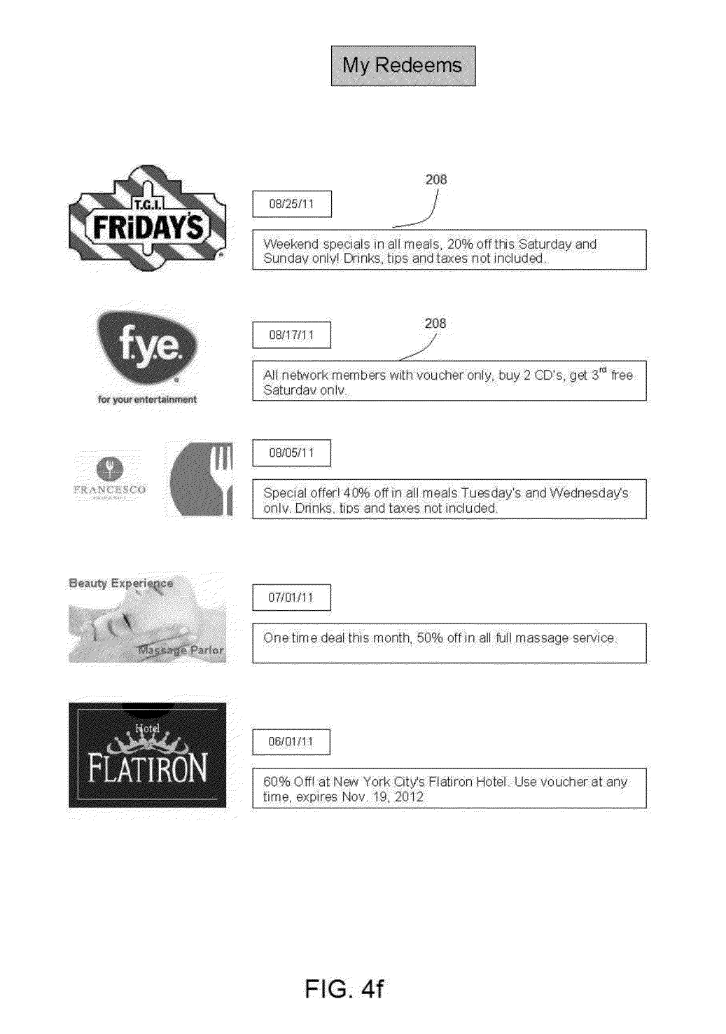

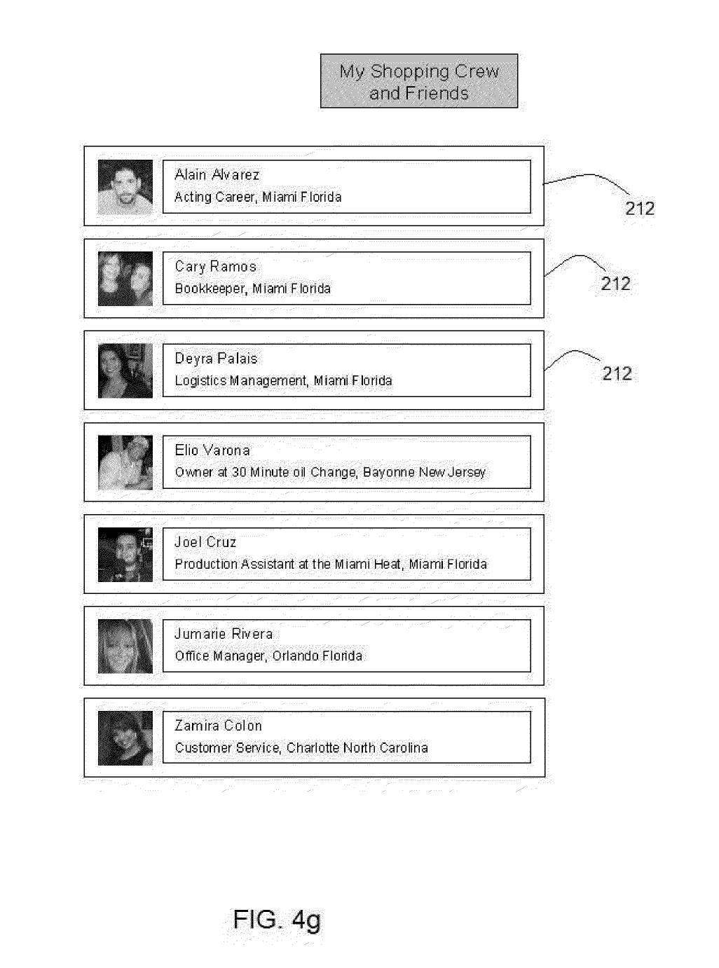

FIGS. 4a through 4g illustrate exemplary trading network online pages for a consumer, in accordance with an embodiment of the present invention. FIG. 4a illustrates an exemplary home page for a consumer that may include numerous options for interactive communication with other network members, and accessing promotions. In some embodiments, the home page may allow the consumer to select a product or service to view, or a particular consumer or merchant to communicate with. The home page may also display comments from other network members regarding a particular product or promotion. In one alternative embodiment, the home page may link to other social sites, including, without limitation, Facebook, Twitter, and Groupon so that members may exchange information with a more diverse group of consumers and merchants. The trading network may also compare merchant prices and qualities with other merchant sites, including, without limitation, Alibaba and Ebay. In some embodiments, the home page may also allow a consumer to perform numerous functions, including, without limitation, moving to a message board, a favorite shopping board, a hangout board, view promotions, view messages from other network members, view referrals, access the account, simultaneously shop and chat with other like-minded consumers, exchange ideas with merchants, and invite new connections. In some embodiments, the consumer may select from a list of email accounts belonging to other network members for efficient communication throughout the network. Merchant logos may automatically appear on the home page to advertise promotions. The consumer may also request that specific merchant information permanently reside on the home page.

FIG. 4b illustrates an exemplary favorite shopping board that includes merchants that may have been preselected by the consumer. However, in some embodiments, the Share Network Engine may select the merchants who appear on the consumer's favorite shopping board. Promotions and information pertinent to the merchant may appear next to the merchant logo to inform the consumer about the most recent offerings. The consumer may select the desired merchant or promotion for moving to a different function, including, without limitation, obtaining and printing vouchers, obtaining and printing coupons, and viewing the merchant's website outside of the trading network. FIG. 4c illustrates an exemplary my messages board for interactive exchange of comments, reviews, and general ideas between network members. In some embodiments, consumers may discuss merchants, products, and services at any time and post recommendations and reviews to each other's message boards. In some alternate embodiments, consumers may be encouraged to post videos, or links to videos, of interactions with the merchant or merchant's facilities. In a non-limiting example a consumer may post a video of a party held at a merchant's restaurant. FIG. 4d illustrates an exemplary shopping alert transmitted to a smart phone. In some embodiments, the shopping alert may appear on the consumer's smart phone at any time, and may promote limited time offers, merchant information, or directions to the merchant's place of business. Those skilled in the art will recognize that the shopping alert may appear in many forms, including, without limitation, a text, an audible signal, a graphical representation, and a vibration. The shopping alert may also transmit at a predetermined time, or at the discretion of the merchant. The merchant may also custom tailor the shopping alert to transmit to a desired group of consumers. FIG. 4e illustrates an exemplary hangout places board that displays merchants that the consumer may have transacted business with in the past. Displaying the merchants may motivate the consumer to perform additional transactions with the merchants, or refer other consumers to the merchants to accrue funds in the consumer's account. In some embodiments, the hangout board may also include the consumer's account information, including, without limitation, individual merchants referred in the past and a tender amount accrued for each merchant by the consumer. In this manner, the merchant may view how much funds are I the account, and which merchant deposited the funds into the account. In some embodiments, the merchant may deposit funds into the consumer's account for performing consumer activities, including, without limitation, referring other consumers, transacting a minmum quota of purchases, and posting positive reviews. FIG. 4f illustrates an exemplary redeems board that displays the status of vouchers for the consumer. The redeems board may display the merchant logo next to descriptive text that describes the voucher information, including, without limitation, amount of the discount, time frame for the discount, and number of uses for the discount. FIG. 4g illustrates an exemplary shopping crew and friends board that lists other network members that the consumer may have simultaneously shopped with on the trading network. In some embodiments, the shopping crew and friends may include like-minded consumers who share similar values and budgets as the consumer. Those skilled in the art, in light of the present teachings, will recognize that the shopping crew and friends may form a consumer association to leverage additional funds, vouchers, and promotions from the merchants.

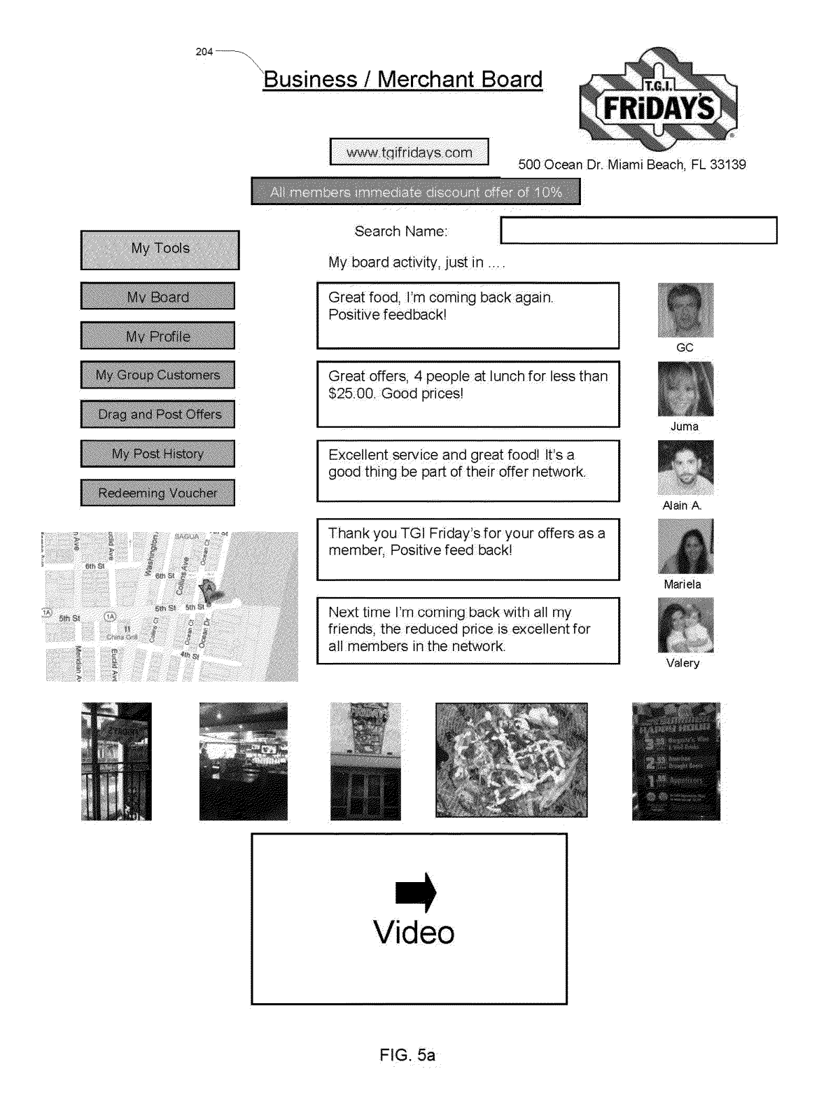

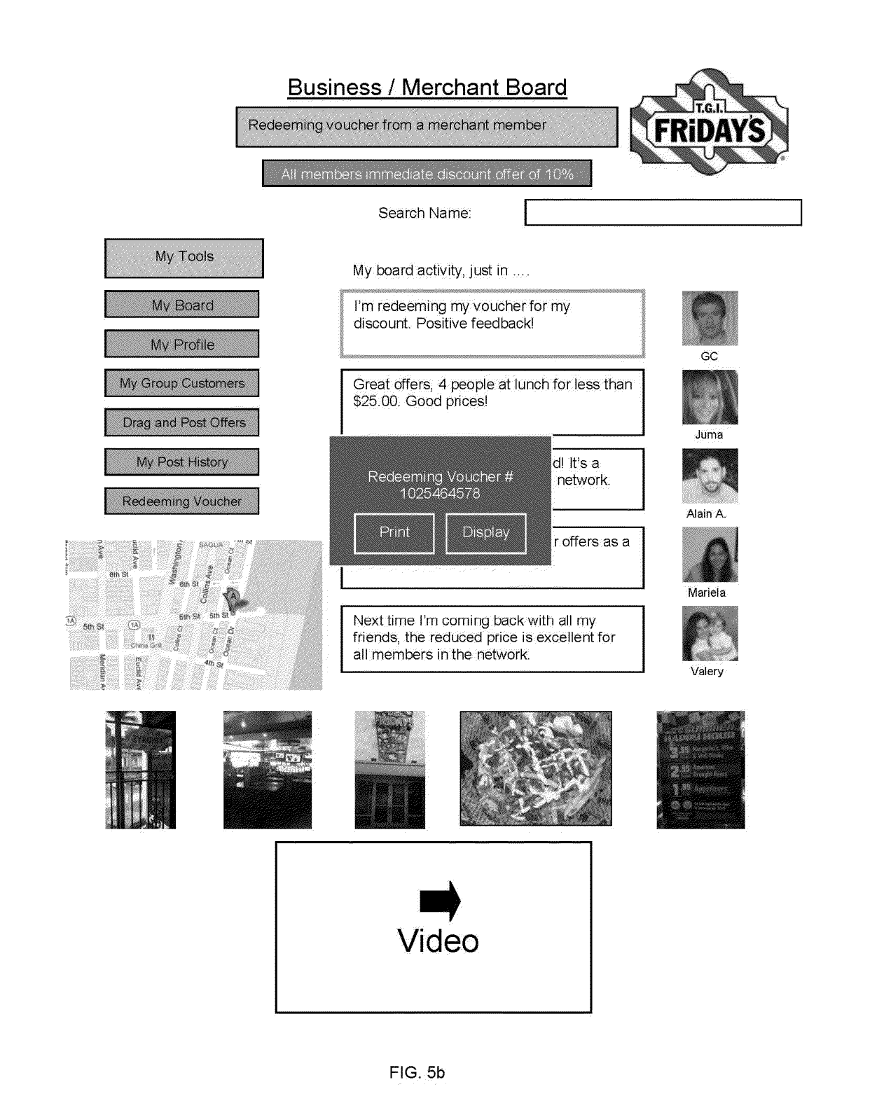

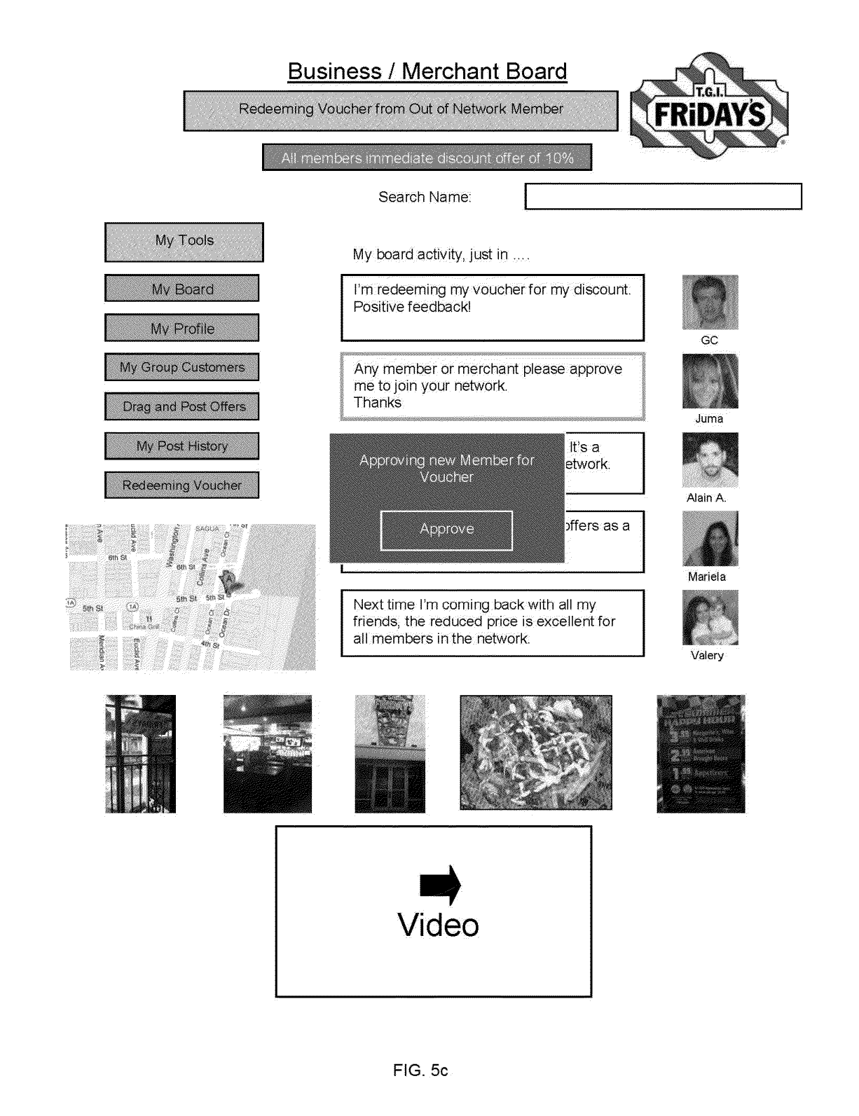

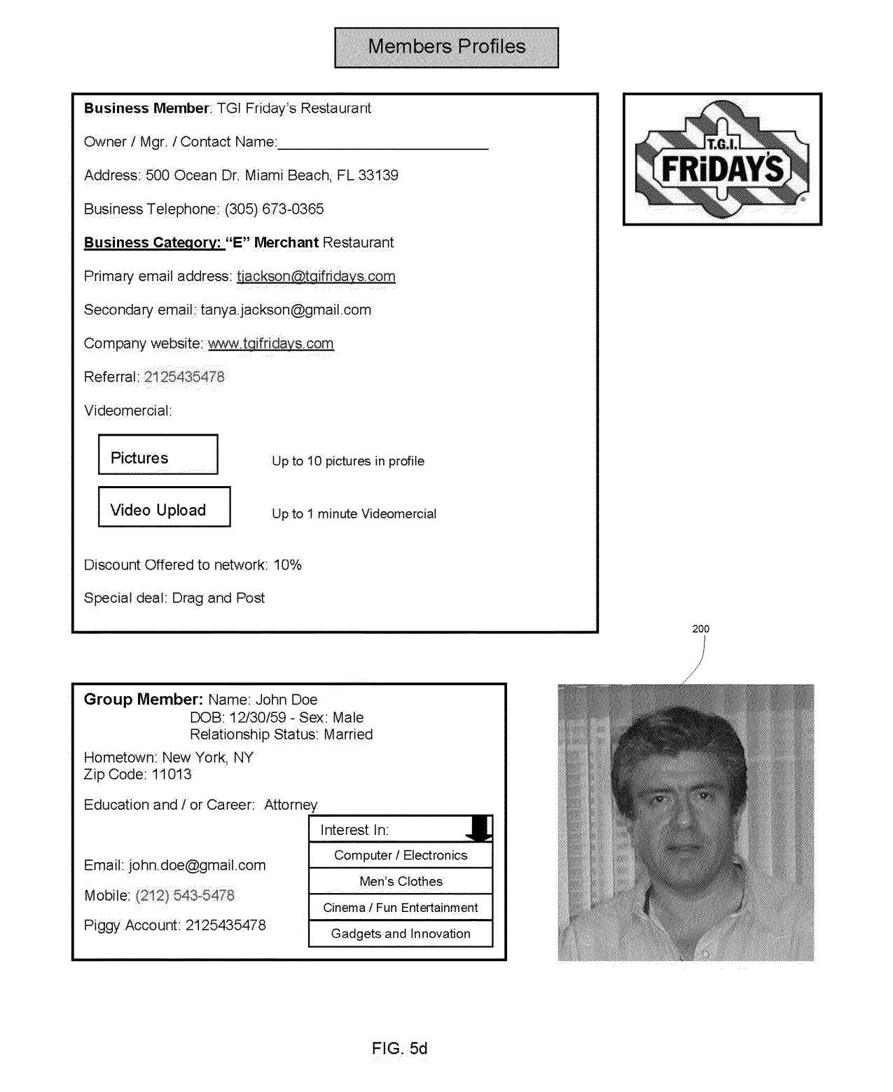

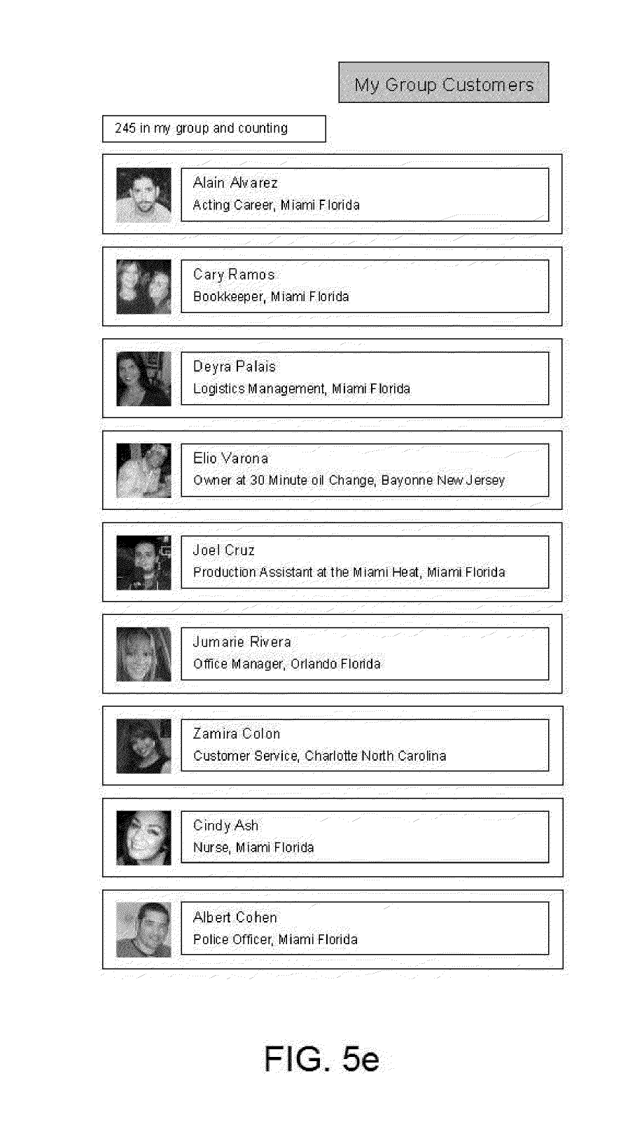

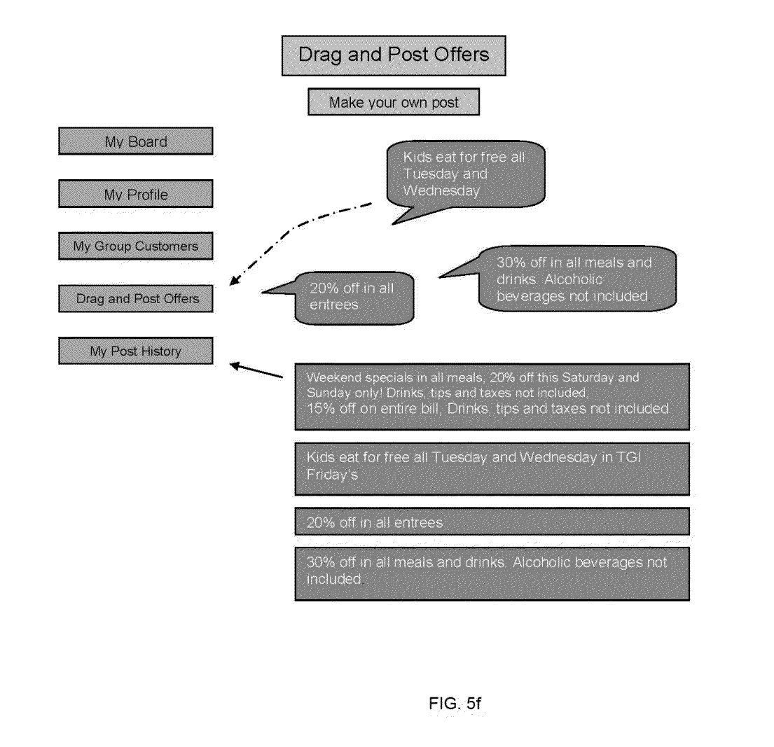

FIGS. 5a through 5f illustrate exemplary trading network online pages for a merchant, in accordance with an embodiment of the present invention. FIG. 5a illustrates an exemplary home page for the merchant. In some embodiments, the home page may operate in real time to inform the merchant about a consumer's needs and complaints. The home page may also display comments from other network members regarding a particular product or promotion. In one alternative embodiment, the home page may link to other social sites, including, without limitation, Facebook, Twitter, and Groupon so that merchants may view and exchange information with a more diverse group of consumers. The home page may allow the merchant to perform numerous merchant related functions including, without limitation, viewing messages and feedback from consumers, viewing consumer purchase activity and history, viewing consumer personal information, posting promotions and vouchers to specific consumers, and redeeming vouchers from consumers. In some embodiments, the merchant may also record and transmit a video of the company, product, or service to the consumer from the home page. In some alternate embodiments, the merchant may also provide a virtual tour of the merchant's facilities. In a non-limiting example, a merchant may provide a virtual tour of their restaurant. In another non-limiting example, a merchant may provide a virtual tour of the products in their store. FIG. 5b illustrates an exemplary merchant home page receiving and processing a voucher from the consumer. The type of voucher displays on the home page. In one alternative embodiment, an expired or fraudulent voucher may not process on the home page, and displays an alert for the merchant. FIG. 5c illustrates an exemplary merchant home page approving a voucher from the consumer. In some embodiments, the Share Network Engine may process and calculate transactions involving vouchers, recording, depositing, and deducting funds to and from the consumer's account. FIG. 5d illustrates an exemplary member profile of the merchant that includes personal information, business information, and promotional information related to the merchant. In some embodiments, the member profile may include, without limitation, personal information, photograph, business licenses, contact information, associations the merchant belongs to, categories of the products and services, promotional information, and merchant video information. In some embodiments, all of the merchant information is available to other network members. However, in other embodiments, a portion of the merchant information is available to other network members. FIG. 5e illustrates an exemplary my group customers board for the merchant to view consumers who have a history of transacting or communicating with and about the merchant. In some embodiments, the group customers board may display numerous consumers and comments the consumers may have posted regarding the merchant. In yet another embodiment, the consumer's transaction habits and voucher status may appear in proximity to the consumer photograph. Those skilled in the art will recognize that the merchant may access information about the consumers to develop a marketing strategy that may include, without limitations, shopping alerts, emailed vouchers, flyers through mail, and text alerts for limited time offers. FIG. 5f illustrates an exemplary graphical user interface function for a drag and post offers board that allows the merchant to control the quantity and type of promotions offered. In some embodiments, the merchant may select a single promotion from a multiplicity of promotions and vouchers. The merchant may then transmit the promotion to numerous channels for offering, including, without limitation, message board, merchant personal page, consumer personal page, email, and text. In some embodiments, the merchant may transmit the offer to an individual consumer, or an association of consumers. The merchant may also automate the process so that the promotion transmits periodically or after a minimum quota of transactions by the consumer. In some alternate embodiments, the merchant may promote a group social activity. In a non-limiting example, the merchant may provide a block of discounted tickets to sporting event or other social event.

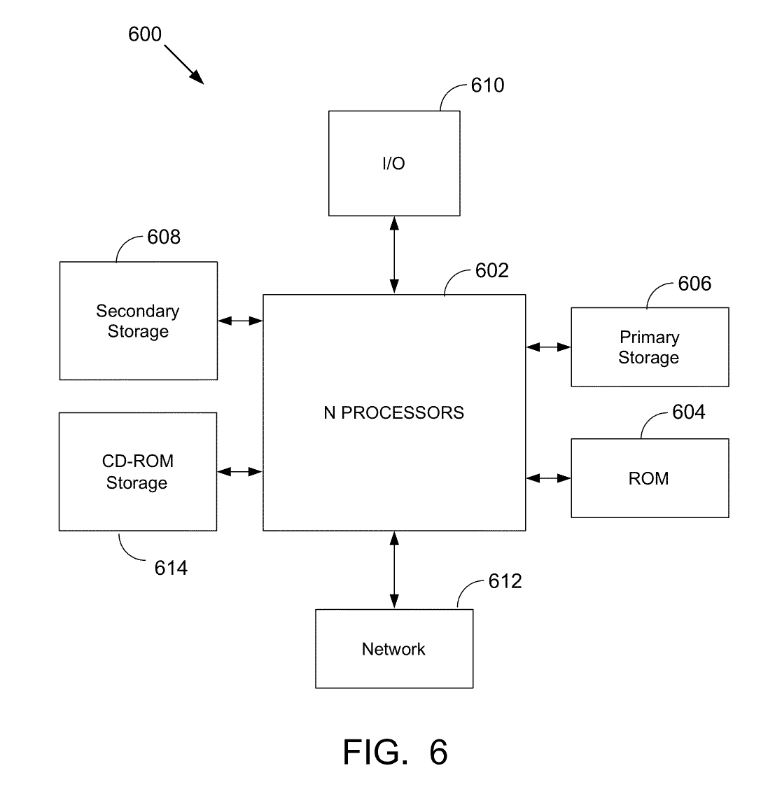

FIG. 6 illustrates a typical computer system that, when appropriately configured or designed, can serve as a computer system in which the invention may be embodied. The computer system 600 includes any number of processors 602 (also referred to as central processing units, or CPUs) that are coupled to storage devices including primary storage 606 (typically a random access memory, or RAM), primary storage 604 (typically a read only memory, or ROM). CPU 602 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 604 acts to transfer data and instructions uni-directionally to the CPU and primary storage 606 is used typically to transfer data and instructions in a bi-directional manner. Both of these primary storage devices may include any suitable non-transitory computer-readable media such as those described above. A mass storage device 608 may also be coupled bi-directionally to CPU 602 and provides additional data storage capacity and may include any of the computer-readable media described above. Mass storage device 608 may be used to store programs, data and the like and is typically a secondary storage medium such as a hard disk. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 may also be coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or internet network using an external connection as shown generally at 612, which may be implemented as a hardwired or wireless communications link using suitable conventional technologies. With such a connection, it is contemplated that the CPU might receive information from the network, or might output information to the network in the course of performing the method steps described in the teachings of the present invention.

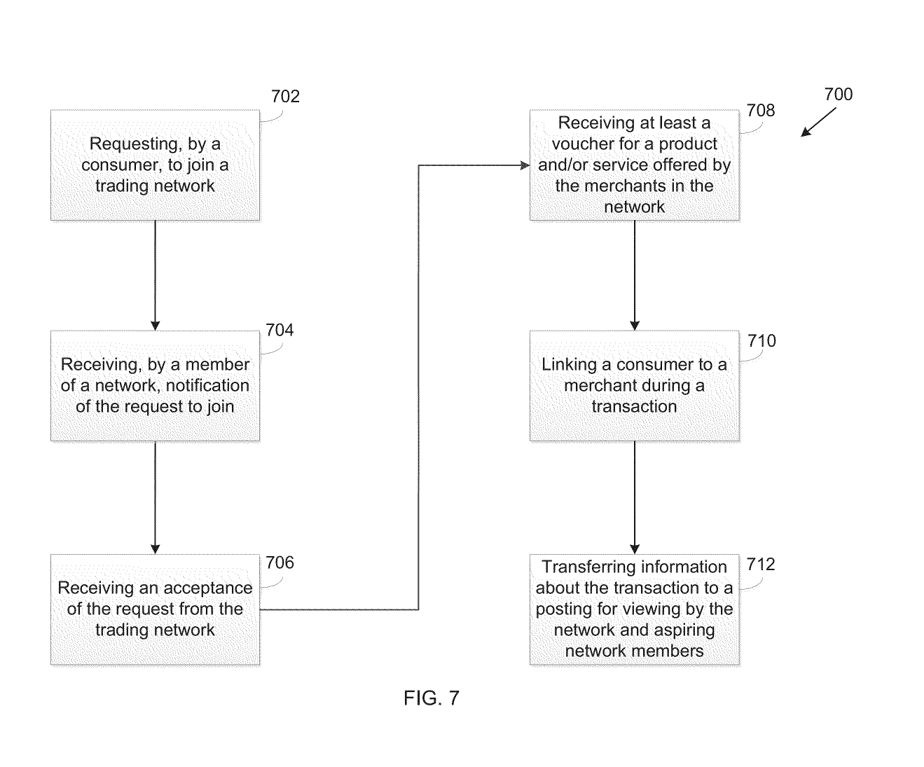

FIG. 7 illustrates a flowchart diagram of an exemplary trading network social site method, in accordance with an embodiment of the present invention. In one embodiment of the present invention, a trading network social site method 700 allows a consumer to identify and utilize the services from members of a network. The members of a network may include, without limitation, merchants, service providers, and product providers. After the consumer utilizes a product or service from the members of a network, the information pertinent to the transaction may be posted for others to view and comment on. In one embodiment, an initial Step 702 may include requesting, by a consumer, to join a trading network. The trading network may include a plurality of merchants. The merchants may perform transactions for similar or dissimilar products and/or services. In one embodiment, the consumer may join a specific category of product or service to receive and transmit information, reviews, and promotional offers pertinent to the product or service. For example, without limitation, the consumer may join a network comprising of a merchant and a multiplicity of consumers for vitamin products. The vitamin network may perform numerous activities pertinent to vitamins, including, without limitation, discussing health issues, exercise techniques, and human anatomy.

The method may include an additional Step 704 of receiving, by a member of a network, notification of the request to join the trading network. The trading network may require the consumer to fill out an application. However, in other embodiments, the consumer may be required to pay a fee for joining the trading network. In some embodiments, the network may include a registration page on a website. The registration page may be configured to receive information from the aspiring member that helps other members in the network understand the potential consumer or merchant needs, habits, products, and services. The information requested may include, without limitation, name, address, email, age, sex, marital status, and the like. The registration page may also include information for assisting the aspiring member to decide whether membership is appropriate, including, without limitation, frequently asked questions, information about the trading network, contact information, and privacy concerns.

A Step 706 may include receiving an acceptance of said request to join a trading network from said member. In some embodiments, any trading network member 212 may approve the requested entry. Upon approval, the consumer may transact with merchants in the trading network.

In some embodiments, a Step 708 may comprise receiving at least a voucher for a product and/or service available from said merchant. The voucher may be purchased by the consumer, serving as a financial instrument within the trade network. In some embodiments, new members may receive a predetermined number of vouchers for free.

A Step 710 may include linking a consumer of said voucher to said merchant. The parties involved in the transaction may be linked and the information stored in a remote data storage site. In this manner, future transactions and marketing efforts may be applied. For example, without limitation, after the merchant learns more about the consumer's transaction preferences, the merchant may provide incentives that the consumer may take advantage of, including, without limitation, discounts for refering and inviting other consumers to the merchant or trading network, discounts for logging on to the trading network website a minimum number per time interval, and discounts for giving a merchant higher reviews. In this manner, the merchant and the consumer create a transaction history, which other members of the network may view and learn from.

A final Step 712 may include transferring information about a transaction to a posting. The posting may include a web site accessible by all the merchants in the network, and any potential consumers. The information may include the type and size of transaction, the cost of the transaction, and a review from the consumer regarding the transaction and the merchant.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: the share network engine and associated modules.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing a social site to match local and out of network merchants retailers and service providers with local buyers around the world for a discount or special deal offer according to the present invention will be apparent to those skilled in the art. Various aspects of the invention have been described above by way of illustration, and the specific embodiments disclosed are not intended to limit the invention to the particular forms disclosed. The particular implementation of the social site to match local and out of network merchants retailers and service providers with local buyers around the world for a discount or special deal offer may vary depending upon the particular context or application. By way of example, and not limitation, the social site to match local and out of network merchants retailers and service providers with local buyers around the world for a discount or special deal offer described in the foregoing were principally directed to matching merchants and consumers, and providing communications channels between members of the trading network; however, similar techniques may instead be applied for matching military personnel and military equipment suppliers, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method comprising the steps of:
requesting to join a trading network of a website, said trading network being established for commercial and social activity, said request being transferred to a share network engine to be posted on an out of network board to be viewable by all consumer members and merchant members, said request being acceptable by any member of said trading network;
receiving an acceptance of said request from said share network engine;
receiving at least a voucher for a product or service provided by at least one merchant member of said trading network; and
transferring information to said share network engine to be at least posted on a board of said trading network.

2. The method as recited in claim 1, further comprising the step of accepting said voucher in which said acceptance of said voucher provides an option for printing said voucher.

3. The method as recited in claim 2, in which said acceptance of said voucher further provides an option of displaying said voucher on a mobile communication device.

4. The method as recited in claim 1, in which said share network engine links a user receiving said acceptance to said at least one merchant member.

5. The method as recited in claim 1, further comprising receiving a home page on said website in which said home page at least provides links for said commercial and social activity.

6. The method as recited in claim 1, in which said information at least comprises experiences with the product or service provided by said at least one merchant.

7. The method as recited in claim 1, in which members of said trading network receive notification of said posting of said request.

8. The method as recited in claim 1, in which said share network engine at least processes information exchange within said trading network.

9. The method as recited in claim 1, in which said share network engine enables merchants to broadcast information to all consumer members in said trading network.

10. A system comprising:
a website at least comprising an out of network board;
at least one trading network associated with said website, said trading network being configured to operable for commercial and social activity, a request to join said at least one trading network being posted on said out of network board to be viewable by all consumer members and merchant members, said request being acceptable by any member of said trading network; and
a share network engine at least being configured to be operable for receiving and posting said request, for communicating said acceptance of said request to a user making said request, for communicating, to the user, at least a voucher for a product or service provided by at least one merchant member of said trading network, and for posting, on a board of said trading network, information received from the user.

11. The system as recited in claim 10, in which said information from the user at least comprises experiences with the product or service provided by said at least one merchant, and in which said share network engine is further configured to be operable for notifying members of said trading network of said posting of said request, for communicating, to the user, options of printing said voucher and displaying said voucher on a mobile communication device, for linking the user to said at least one merchant member, for establishing, for the user, a home page on said website in which said home page at least provides links for said commercial and social activity, for processing information exchange within said trading network, and for enabling merchants to broadcast information to all consumer members in said trading network.

12. A non-transitory computer-readable storage medium with an executable program stored thereon, wherein the program instructs a processor to perform the following steps:
requesting to join a trading network of a website, said trading network being established for commercial and social activity, said request being transferred to a share network engine to be posted on an out of network board to be viewable by all consumer members and merchant members, said request being acceptable by any member of said trading network;
receiving an acceptance of said request from said share network engine;
receiving at least a voucher for a product or service provided by at least one merchant member of said trading network; and
transferring information to said share network engine to be at least posted on a board of said trading network.

13. The program instructing the processor as recited in claim 12, further comprising the step of accepting said voucher in which said acceptance of said voucher provides an option for printing said voucher.

14. The program instructing the processor as recited in claim 13, in which said acceptance of said voucher further provides an option of displaying said voucher on a mobile communication device.

15. The program instructing the processor as recited in claim 12, in which said share network engine links a user receiving said acceptance to said at least one merchant member.

16. The program instructing the processor as recited in claim 12, further comprising receiving a home page on said website in which said home page at least provides links for said commercial and social activity.

17. The program instructing the processor as recited in claim 12, in which said information at least comprises experiences with the product or service provided by said at least one merchant.

18. The program instructing the processor as recited in claim 12, in which members of said trading network receive notification of said posting of said request.

19. The program instructing the processor as recited in claim 12, in which said share network engine at least processes information exchange within said trading network.

20. The program instructing the processor as recited in claim 12, in which said share network engine enables merchants to broadcast information to all consumer members in said trading network.
